(19) United States
(12) Patent Application Publication
(10) Pub. No.: US 2009/0207993 A1
(43) Pub. Date: Aug. 20, 2009

(54) TEMPORALLY DEFINED CONTACT DEFAULT NUMBER FOR TELEPHONE

(75) Inventors: Scott Edwards Kelso, Durham, NC (US); John Carl Mese, Cary, NC (US); Nathan J. Peterson, Raleigh, NC (US); Rod David Waltermann, Rougemont, NC (US); Arnold S. Weksler, Raleigh, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 12/031,479

(22) Filed: Feb. 14, 2008

(51) Int. Cl. H04M 3/42

(52) U.S. Cl. 379/216.01; 379/201.01

(57) ABSTRACT

When a contact in an electronically-stored phone book has more than one telephone number associated with the contact's name, a user is permitted to define times (and if desired day/dates) for which each number is to serve as the default number for the contact, so if the user selects the contact's name from a list or enters the contact's speed dial shortcut number, the number called by default changes depending on the time of day/date.

### FIELD OF THE INVENTION

The present invention relates generally to temporally-defined contact default numbers for telephones.

### BACKGROUND OF THE INVENTION

Mobile telephones can store multiple telephone numbers for each contact in the address book of the phone, but as understood herein the number used as default when a user, e.g., selects a speed dial shortcut associated with the contact remains static. The present invention recognizes that the best primary number with which to reach a contact can vary with date and time.

### SUMMARY OF THE INVENTION

A telephone has a communication interface, a processor controlling the communication interface, and a computer-readable storage medium accessible by the processor. The telephone also has a visual display receiving signals from the processor and a data input entry keypad communicating signals to the processor. A user can associate at least first and second telephone numbers with a contact. The processor establishes which of the first and second telephone numbers is the default number for the contact based on one or more temporal parameters selected from the group of temporal parameters consisting of: time of day, date, day of the week.

The interface can be, without limitation, a wireless telephony interface or a voice over Internet communication interface. The temporal parameter typically is received from the keypad. In some embodiments the first and second telephone numbers are each correlated to at least one respective default temporal parameter.

In non-limiting implementations the default number is called in response to a user selecting a name of the contact from a list of names and then commanding the telephone to commence a transmission. In other non-limiting implementations the default number is called in response to a user selecting a speed dial shortcut associated with the contact and then commanding the telephone to commence a transmission.

In another aspect, a tangible computer readable medium stores logic to cause a processor to store plural contacts. For at least one contact, the processor is caused to store more than one telephone number associated with it and to also store a respective temporal parameter for each telephone number associated with the contact. The parameter defines when the associated telephone number is to be called when a user selects to call the contact.

In still another aspect, a telephone automatically and dynamically changes a default number that will be dialed when a user selects to call a contact based on at least one temporal parameter predefined by the user.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic front elevational view of a telephone in accordance with present principles;

FIG. 2 is an example data structure that can be used by the telephone of FIG. 1;

FIG. 3 is a flow chart of example logic that the telephone of FIG. 1 may use; and

FIG. 4 shows two screen shots presented by the telephone of FIG. 1 for the same contact and speed dial shortcut at different times of day.

### DETAILED DESCRIPTION OF THE PREFERRED EMBODIMENT

A telephone 10 is shown in FIG. 1 that may be a wireless telephones in which case the telephone 10 can have a communication interface 12 that is a wireless telephony interface such as but not limited to a code division multiple access (CDMA) receiver/transmitter or global system for mobile communication (GSM) receiver/transmitter or time division multiple access (TDMA) receiver/transmitter or frequency division multiple access (FDMA) receiver/transmitter or space division multiple access (SDMA) receiver/transmitter or wideband-CDMA receiver transmitter or orthogonal frequency division multiplexing (OFDM) receiver/transmitter, in any case an interface typically mounted in a mobile hand-held housing 14. The telephone 10 may not be wireless, but may be, e.g., Internet-enabled, in which case the interface 12 can be, without limitation, a voice over Internet Protocol (VOIP) receiver/transmitter. The telephone 10 may even have an interface 12 that is a plain old telephone system (POTS) receiver/transmitter.

The telephone 10 can have a processor 16 that accesses logic and stores data on a tangible computer readable medium 18 which may be, without limitations solid state storage, optical or hard disk storage, etc. The processor 16 can receive user input from a keypad having, without limitation, number keys 20, an asterisk key 22, a pound sign key 24, a send or transmit key 26, and end transmission key 28, a clear entry key 30, and an OK or enter key 32. The processor 16 can output information on a visual display 34, typically a small matrix-type display.

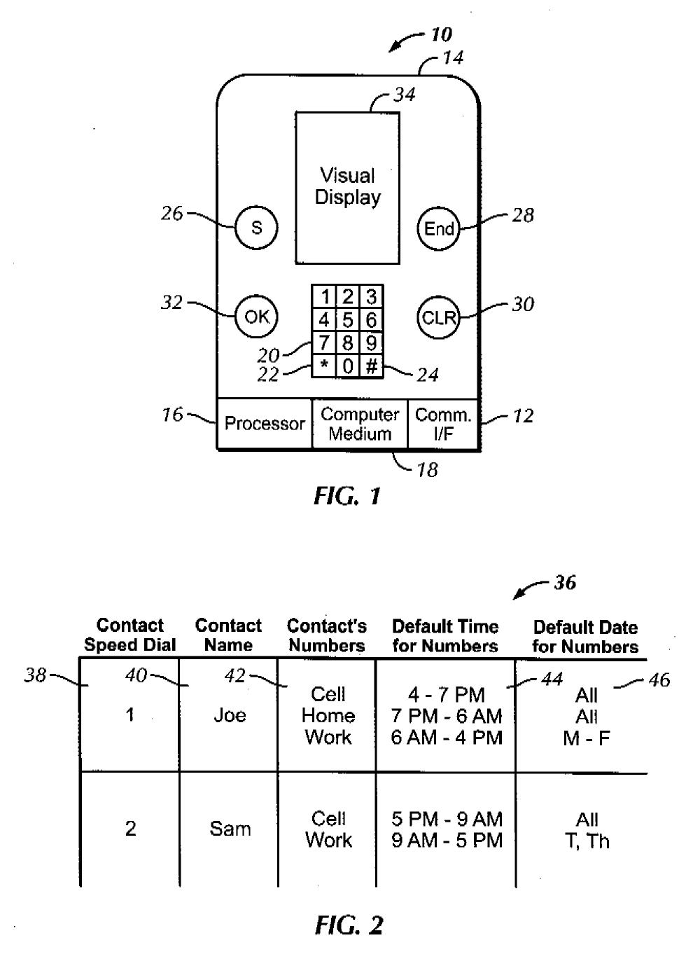

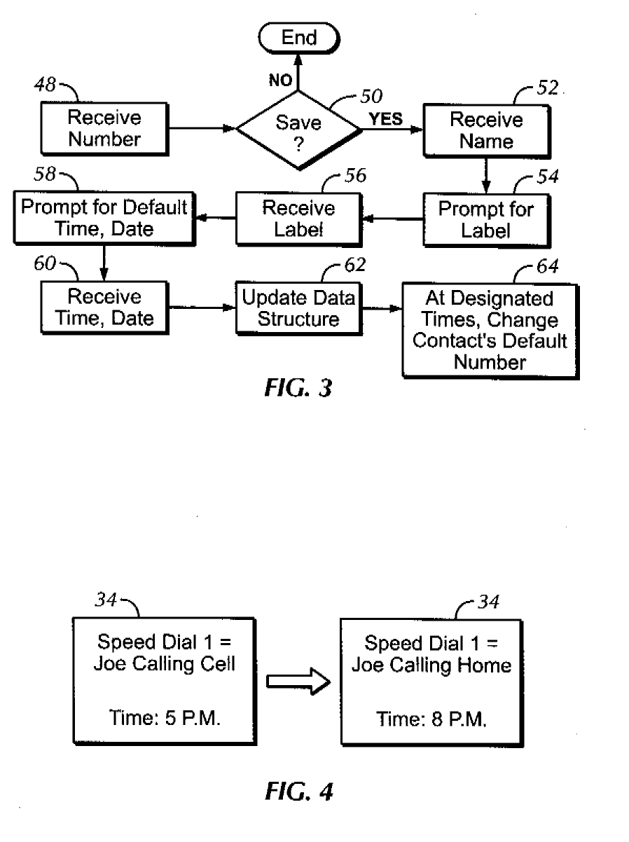

FIG. 2 shows an example non-limiting data structure 36 in tabular form that can be stored in the medium 18 based on logic of FIG. 3 discussed further below. A speed dial column 38 and name column can together correlate a speed dial shortcut (such as the numeral “1”) with a name (such as “Joe”). The name can be correlated to plural telephone numbers in a contact number column 42. A default time column 44 can correlate a default time (which term includes “time period”) to each number in the number column 42 as shown. If desired, a default date column 46 can further correlate dates (which term includes both calendar dates and days of the week) for the default times in the time column 44.

Using the contact entry “Joe” as an example, the data structure 36 indicates that regardless of the date, Joe's cell phone number is to be used as the default from 4 P.M.-7 P.M. should the user of the telephone 10 enter a desire (by, e.g., inputting speed dial shortcut “1” or selecting Joe's name from a list presented on the display 34) to call Joe. Likewise, regardless of the day if the user inputs a command to call Joe during the period 7 P.M.-6 A.M., the processor 16 will use Joe's home phone number as the default number to call. During the period between 6 A.M. and 4 P.M., on Monday-Friday only, Joe's work telephone number will be set as default. It is to be understood that instead of or in addition to days, specific dates may be entered in the date column 46.

FIG. 3 shows example logic that can be used to generate and then use the data structure of FIG. 2 At block 48, the processor 16 receives a telephone number input by, e.g., a user manipulating the number keys 20. At decision diamond 50 it is determined whether the user wants to save the number, e.g., by selecting a “save” element on a GUI presented on the display 34, and if so the logic saves the number to, e.g., the data structure 36.

At block 52, a name to be correlated to the number is received in response to, e.g., a prompt on the display 34 to “enter name”. This name is saved and then at block 54 a prompt for a label such as “home”, “work”, cell” can be presented on the display 34. The label as input by the user is received at block 56 and stored. It is to be understood that the name can be associated with a speed dial shortcut number if desired in accordance with principles known in the art. In effect, after block 56 data has been entered in the first three columns 38, 40, 42, or at least the second and third columns 40, 42 of the data structure 36 shown in FIG. 2 if no shortcut it to be used with the name under test Block 58 indicates that for each label, a prompt can be made to appear on the display 34 for the user to enter a time and/or time period and/or date at which the label becomes the default number of the particular contact, and the user's decision is received at block 60 and stored in the last two columns (when time and date are entered) or second to last column (when only time is used) of FIG. 2. A user interface that may be presented on the display 34 to this end can include (for time) a watch face from which a user can select, using the entry keys shown in FIG. 1 times during which the number is to be set as default. Or, the numeral keys 20 may be used to input time directly. A calendar can be presented in the case of date/day entry. Other user interfaces can be used to permit the user to define times and dates in accordance with present principles.

The data structure 62 is updated accordingly at block 62. Completing the logic at block 64, when a designated time/date has been reached for a particular contact, the processor 16 automatically switches the default for that contact to the number correlated to the existing time/date.

FIGS. 2 and 4 illustrate. When a user enters speed dial shortcut numeral “1” (or when the user otherwise enters a desire to call “Joe”) and the present time is 5 P.M., the processor automatically dials Joe's cell phone, since the time column 44 in FIG. 2 indicates that for all dates, during the period 4 P.M.-7 P.M. Joe's cell phone is preferred. Essentially, when a user enters a contact to call, the processor 16 looks up which number associated with the contact to default to. Unless the user scrolls through Joe's other numbers to select an alternate number from Joe's list, manipulating the “send” key 26 causes the phone 10 to dial the current default number, in this example, Joe's cell phone, as shown in the left-hand screen shot of FIG. 4.

In contrast, if the current time is 8 P.M. as shown in the right-hand screen shot of FIG. 4, the processor 16 presents Joe's home number as default and calls it in response to a “send” command. This is because, as shown in FIG. 2, the user has defined Joe's home number to be the default number for Joe between the hours of 7 P.M. and 6 A.M. In other words, the processor 16 automatically and dynamically changes the default number that will be dialed when a user selects a contact to call based on the time of day and/or date and/or day of the week as predefined by the user.

While the particular TEMPORALLY DEFINED CONTACT DEFAULT NUMBER FOR TELEPHONE is herein shown and described in detail, it is to be understood that the subject matter which is encompassed by the present invention is limited only by the claims.

What is claimed is:

1. A telephone comprising:
at least one communication interface;
at least one processor controlling the communication interface;
at least one computer-readable storage medium accessible by the processor;
at least one visual display receiving signals from the processor;
at least one data input entry keypad communicating signals to the processor, whereby a user can associate at least first and second telephone numbers with at least a first contact; wherein
the processor establishes which of the first and second telephone numbers is the default number for the contact based at least in part on at least one temporal parameter selected from the group of temporal parameters consisting of: time, date.

2. The telephone of claim 1, wherein the interface is a wireless telephony interface.

3. The telephone of claim 1, wherein the interface is a voice over Internet communication interface.

4. The telephone of claim 1, wherein the temporal parameter is received from the keypad.

5. The telephone of claim 1, wherein the first and second telephone numbers are each correlated to at least one respective default temporal parameter.

6. The telephone of claim 1, wherein the default number is called in response to a user selecting a name of the contact from a list of names and then commanding the telephone to commence a transmission.

7. The telephone of claim 1, wherein the default number is called in response to a user selecting a speed dial shortcut associated with the contact and then commanding the telephone to commence a transmission.

8. A tangible computer readable medium storing logic to cause a processor to:
store plural contacts;
for at least one contact, store more than one telephone number associated with it; and
store at least one respective temporal parameter for each telephone number associated with the contact, the parameter defining at least in part when the associated telephone number is to be called when a user selects to call the contact.

9. The medium of claim 8, wherein the medium is associated with a wireless telephone communicating using a wireless telephony interface.

10. The medium of claim 8, wherein the medium is associated with a telephone communicating using a voice over Internet communication interface.

11. The medium of claim 8, wherein the temporal parameter is received from a telephone keypad.

12. The medium of claim 8, wherein the telephone numbers are each correlated to at least one respective default temporal parameter.

13. The medium of claim 12, wherein the default number is called in response to a user selecting a name of the contact from a list of names and then commanding a telephone to commence a transmission.

14. The medium of claim 12, wherein the default number is called in response to a user selecting a speed dial shortcut associated with the contact and then commanding a telephone to commence a transmission.

15. A telephone automatically and dynamically changing a default number that will be dialed when a user selects to call a contact based on at least one temporal parameter predefined by the user.

16. The telephone of claim 15, wherein the telephone uses a wireless telephony interface.

17. The telephone of claim 15, wherein the telephone uses a voice over Internet communication interface.

18. The telephone of claim 15, wherein the temporal parameter is time.

19. The telephone of claim 15, wherein the temporal parameter is day of the week.

20. The telephone of claim 15, wherein the temporal parameter is date.
